(19) United States
(12) Patent Application Publication
(10) Pub. No.: US 2005/0269541 A1
(43) Pub. Date: Dec. 8, 2005

(54) Adapter and its use

(76) Inventor: Jorgen Bodum, St. Niklausen (CH)

Correspondence Address: NATH & ASSOCIATES, 1030 15th STREET, NW, 6TH FLOOR, WASHINGTON, DC, 20005, US

(21) Appl. No.: 10/530,676

(22) PCT Filed: Oct. 11, 2002
(86) PCT No.: PCT/DK02/00684

§ 371 Date: Jul. 26, 2005

(51) Int. Cl. F16K 51/00

(52) U.S. Cl. 251/144

(57) ABSTRACT

An adapter connecting between a rigid container with one drain opening and a liquid demanding device, comprises one attachment port for sealing connection to the container's drain opening and a valve connecting to the flow-passage between the attachment port and connection means for the liquid demanding device, for equalizing pressure inside the container. Characterizing means are: attachment means (2) to keep a container sealingly attached in the drain opening; connection means (7) having externally a prismatic or cylindrical form (10) fitting in a corresponding deep hole in the device, wherein a sealing to the prism or cylinder's surface between the interior of the deep hole and the surroundings is established; and a take-out valve (11) in the flow direction in the connection port (8), being opened by means in the device (9) after sealing to the prism or cylinder (10) has been established. Easy connection to various containers and no spillage when not in use are the main benefits.

### FIELD OF THE INVENTION

The present invention relates to an adapter and the use of same.

### PRIOR ART

From WO98/20832 an adapter is known with respectively attachment and connection means to establish both physical fit and flow connection between:
a container with one drain opening, otherwise closed—and being substantially rigid and
an at least occasionally liquid demanding device, respectively.

The attachment means comprise one attachment port for connection to the drain opening of at least one detachable, and possibly replaceable, container, with sealing properties compared to the surroundings, and a valve being placed in fluid connection with the flow passage between the attachment port and the connection means for the liquid demanding device for automatically equalizing pressure inside the container compared to the surrounding pressure substantially simultaneously with the devices' draining of liquid from an attached container of the type mentioned. In WO98/20832 the at least occasionally liquid demanding device is for example constituted of a sucking baby as the container is a feeding bottle.

The adapter according to WO98/20832 has the severe disadvantage that liquid draining through the connection means is not unambiguous controlled, when the adapter has been removed from the liquid demanding device, with the consequence, that liquid easily will be spilled. Furthermore the mounting of the container on the attachment means is much elaborated because of the special shape of the attachment means external to the drain opening of the container.

The purpose of the present invention is to improve the known and mentioned adapter and to remedy the above drawbacks.

The above purpose is fulfilled with the adapter according to present invention comprising the features as specified in claim 1. By utilizing the characterising means and features of the adapter according to the invention, the adapter can be kept sealed, thus avoiding any waste of liquid escaping from the container, while there is no sealing established to the connection port. This because the means in the devices for opening the take-out valve can only be effective, while that sealing is established. Further the attaching means according to the invention remarkably simplifies the mounting or replacement of a liquid-containing or empty container on the adapter of the invention, now being established via a sealing friction fit in the drain opening.

Preferably the sealing attack of the attachment means in the outlet of the container is resulting in a mutual cohesive force, which is distinctively superior to the force produced by the sealing or positioning to the prism or cylinder, regardless of actual size of the container, and actual quantity and type of liquid present inside the container, resulting in, that said adapter correctly mounted according to a directions, will stay connected to the container in the case of the adapter's removal from the device by force influenced on the container.

Thus the risk that a force contribution from even a high level of a column of heavy liquid can press the adapter out of the outlet area of the container in the moment of the most critical force related situation, where the adapter is getting removed from the device, inter alia overcoming the sealing forces at the connection port, is avoided; the size of the container will often promote the container body and not the adapter body being influenced by the external force for the removal of the adapter plus container from the device; the attachment means are able to provide a heavy sealing grip between the container and the adapter. Thereby it is avoided that the adapter remains connected to the device, while the container is being removed from the adapter with probably waste of liquid as a consequence.

Preferably the attachment means having contact with the drain opening wall consists of an elastomer. The attachment means can hereby easier take up irregularities and dimension tolerances in the outlet area of the container and secure a safer sealing; at the same time there will be no requirement for a sealing elasticity of the container's material round the outlet area.

Preferably the attachment means for contact in the outlet area can be shaped as an overall truncated cone pointing in the liquid upstream direction. The same adapter can by this means be used in different containers' outlet area with differing internal diameters according to a dimensional interval defined by the size of the truncated cone.

Preferably the overall truncated cone detailed can have a towards the tapered end constantly stepped form substantially shaped as successively alternating adjacently placed circumferential ribs and grooves with constantly decreasing respective characterizing diameter to the tapered end. Thus a better defined force or sealing against the actual container's outlet area is achieved, as a rib with smaller diameter further inside the outlet area can execute the sealing function against the outlet area internal wall and other ribs of larger diameter can provide a heavy force contributing to the cohesiveness of the container and the adapter, even if the larger diameter material is stressed beyond its sealing limit and/or is only partly being in touch with the edge of the outlet area.

Preferably the flow conduit of the pressure equalizing valve can join to the flow passage immediately upstream of the take-out valve. Thus an adapter having an extreme short distance between the device and the container can be provided, so that a more stable stack can be achieved, when the container is only supported on the adapter placed in the deep hole of the device. Moreover a smaller overall dimension of the container and adapter combination can be realized, being beneficial e.g. during storing in confined volumes like refrigerators.

Preferably the valve part of the pressure equalizing valve is biased in the cut-off position by a flexible, preferably elastic, biasing force so small, that the pressure equalizing valve can open for pressure compensation with the fluid level being on level with the free surface of the attachment means in the outlet.

Thus all liquid in the container can be drained by the device and be utilized.

Preferably the means of the device for opening of the take-out valve can be controllable. Consequently liquid can be taken out of the device as needed, as the take-out flow area through the take-out valve possibly occasionally can be blocked or regulated, while the adapter is connected to the device.

Preferably the elastomer of the attachment means can be shaped as a sleeve, which is mounted on a supporting, preferably tubular, structure of the adapter body, yielding an increased sealing force ability, because the backing tubular structure inside can brace the elastic sleeve.

Preferably the body of the adapter is shaped by moulding, preferably by injection moulding, leaving possibility to produce the adapter body in a rational and cheap way, e. g. from a plastic.

Preferably the adapter's flow passage from the container to the device can be substantially linear, yielding possibility for optimal flow.

Preferably the attachment means can be designed for attacking the actually utilized container exclusively in the outlet, yielding total independence of the remaining structure of the actual container to the attachment means.

Preferably the liquid contained and used can be drinking water, preferably mineral drinking water, leaving possibility to use the adapter according to the present invention in relation to preparation of food or drinks.

Preferably the container can be a bottle, preferably of transparent plastic material, preferably approved for use with human food. Thus e.g. easy-to-get returnable and/or recyclable bottles of standard or proprietary design from the consumer market, containing e.g. mineral drinking water can be used with the adapter of the invention.

Preferable the device used can be a domestic appliance such as an espresso machine. Utilizing this option in connection with relevant above mentioned features or options, e.g. a gourmet can prepare for himself a superb coffee drink from a selected mineral drinking water stored when not in use in the original bottle being constantly sealed with the adapter according to the present invention and being meanwhile stored in a refrigerator.

Illustrative—in no way limiting—examples of preferred embodiments of the adapter according to the present invention are now being discussed in further detail, referring to the accompanying drawing.

### DESCRIPTION OF THE FIGURES

FIG. 1a shows a preferred embodiment of an adapter 1 according to the invention as seen in a frontal elevation, the attachment means 2 pointing upwards,

FIG. 1b shows the adapter from FIG. 1a sectioned in its central plan parallel to drawing plane,

FIG. 2 shows an exploded view of the inventions' adapter of FIG. 1,

FIG. 3 shows an adapter according to the present invention used with a bottle and a partly shown espresso machine, and

FIG. 4 shows a lying bottle fitted with an adapter according to the invention.

### DESCRIPTION OF PREFERRED EMBODIMENTS

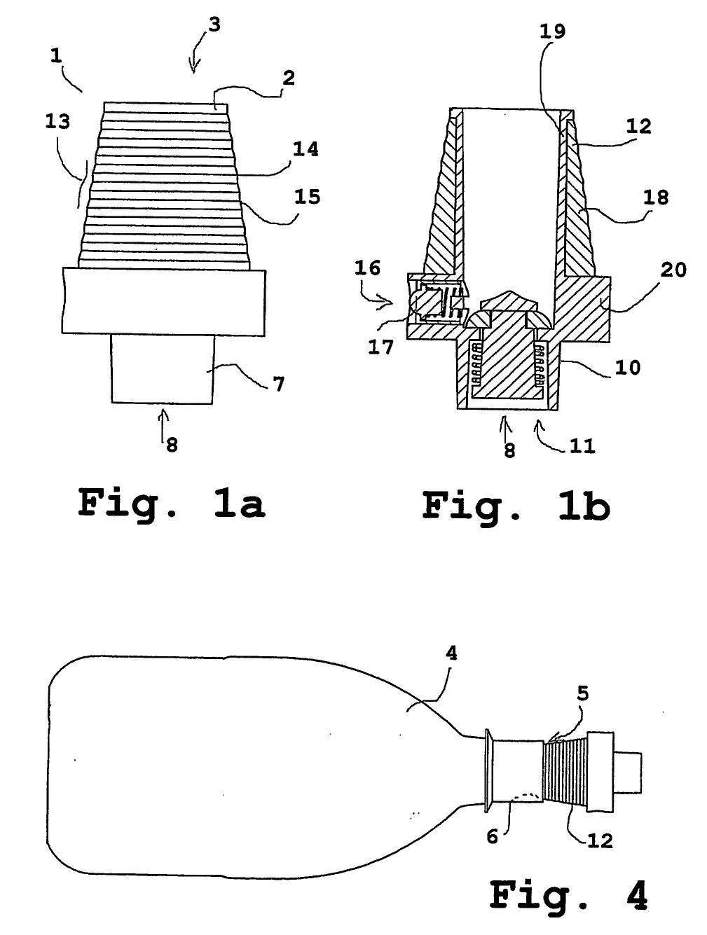

Reference is now made to the FIGS. 1a-4, wherein same reference numbers are used in all the figures for same or similar items.

FIG. 1a shows a frontal elevation of a preferred embodiment of an adapter 1 according to the invention, the attachment means 2 pointing upwards. The attachment means 2 are configured as an attachment port 3 for a sealing, forced attack in the drain opening 5 outlet area of a container 4, e.g. a bottle (see FIG. 4: 4, 5, and 6). The lower part of the adapter 1 consists of connecting means 7 configured as a connection port 8, whose external part being prismatic or cylindrical for a telescoping fit in a corresponding deep hole of suitable profile depth in a receiving device 9 to yield a seal around the circumference of the prism or cylinder (FIG. 1b: 10) at telescoping placement of the connection port 8 in the deep hole at least some distance before reaching the bottom.

FIG. 1b shows the adapter 1 from FIG. 1a sectioned in its central plane parallel to the drawing plane. The spring biased take-out valve 11, inside the connection port 8 is shown in the closed, uninfluenced condition.

The device 9 has as mentioned means for opening the take-out valve 11, when there is a need for intake of liquid into the device 9.

These opening means of the device 9 do not automatically have to activate the take-out valve 11 during the final part of the relative, telescopic movement of the prism or cylinder 10 and the deep hole after the sealing around the take-out port 8 has been established. Thereby, the take-out valve 11 is constantly kept open for constant outlet of liquid from the container 4 to the device 9, while an adapter and bottle combination is positioned on the device 9, as the means of the device 9 for opening the take-out valve 11 can be controllable. Consequently liquid can be taken out by the device 9 as needed, as the take-out flow area through the take-out valve 11, possibly occasionally, can be blocked or regulated, while the adapter 1 is connected to the device.

The valve part 17 of the pressure equalizing valve 16 is biased in the cut-off position by a flexible, preferably elastic, biasing force so small, that the pressure equalizing valve 16 can open for pressure compensation with the fluid level being on level with the free surface of the attachment means 2 in the outlet. Thus all liquid in the container 4 can be drained by the device and be utilized, as the pressure equalizing valve 16 now let in a compensating air volume from the surroundings to the container 4 over the remaining level of liquid, even with the lowest level of liquid, with the consequence that the container 4 efficiently can be emptied of liquid.

As seen from FIG. 1b the flow conduit of the pressure equalizing valve 16 can connect to the flow passage immediately upstream of the take-out valve 11. Thus an adapter 1 having an extremely short distance between the device 9 and the container 4 can be provided, so that a more stable stack can be achieved, when the container 4 is only supported on the adapter 1 placed in the deep hole of the device. Moreover, a smaller overall dimension of the container and adapter combination can be realized, being beneficial e.g. during storing in confined volumes like refrigerators or the like when not in use; i.e. you can advantageously store and cool (down) the bottle 4 and the adapter 1 as a unit and later on quickly mount the unit (bottle 4 inclusive liquid and adapter 1) onto the device 9. Therefore it is not necessary to remove the bottle 4 from the adapter 1, before all the contained liquid has been drained.

It is within the scope of the present invention that a system can be established comprising one or more devices functioning correlated to one or more containers mounted with “its own”, freely alternating, and/or in relation to one or more devices and/or containers and/or liquids dedicated, adapters, being an advantage, as for example user can protect against unwanted use of the liquid content of specific container(s) of in a given device. As an example, in a household a first container 4 contains e.g. soup, which just has to be heated in a first type of device before consumption, and consequently, connection port 8 of adapter in this container could, for example, have a rounded pentagonal profile and fit in the correspondingly outlined deep hole in the relevant device 9, while an adapter 1 to a second container 4 with special brewing water for tea can have another profile of the connection port 8 fitting into a dedicated tea brewing device's deep hole.

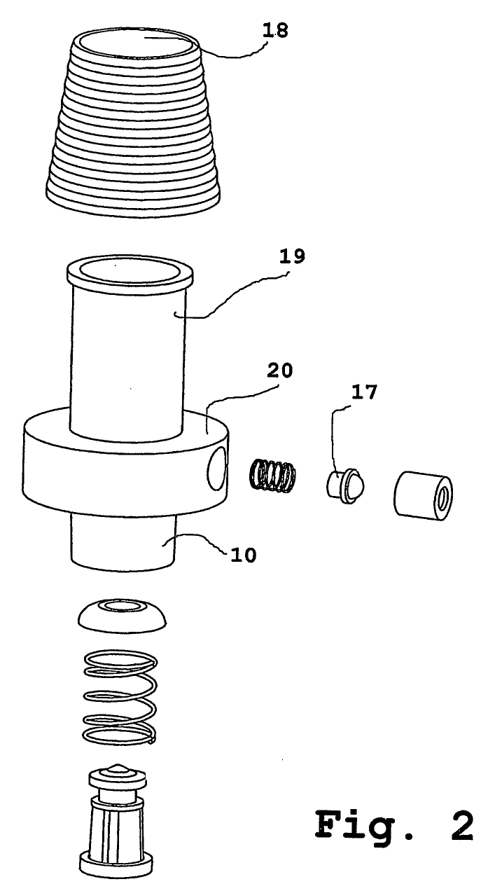

FIG. 2 shows that the elastomer 12 of the attachment means 2 can be shaped as a sleeve 18, which is mounted on a supporting, preferably tubular, structure 19 of the adapter body 20, yielding an increased sealing force ability, because the backing tubular structure 19 inside can brace the elastic sleeve 18.

As seen, the adapter 1 does not have to be constructed of the same material all over; thus leaving the possibility for quality optimisation by choice of the best suited materials for each given function segment of the assembled adapter 1.

FIG. 2 also shows—without neither reference numbers, nor further explanation—usual components of known types of pressurised valves, which in this non-limiting example are used as the pressure equalizing valve 16 and the take-out valve 11, respectively.

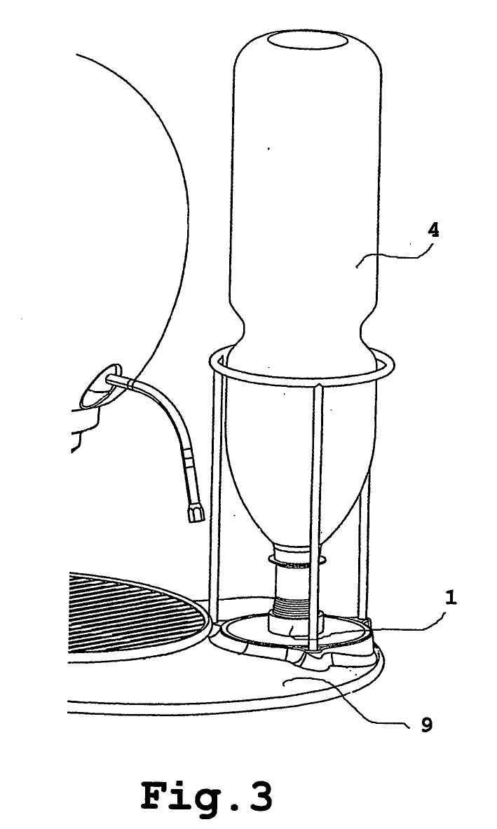

FIG. 3 discloses partly an example of a device 9 configured as an espresso machine. The adapter 1 is here shown mounted in a container 4, which is exemplified as a plastic bottle in a usual size for mineral drinking water for example for 1, 1½, or 2 litres. Other container 4 types and sizes can of course be used inside the scope of the claimed protection.

The bottle 4 with the adapter 1 connected is as a unit placed in the device's 9 deep hole, which can not be seen on FIG. 3, as the deep hole has included the adapter's connection port 8 prism or cylinder body 10, thus also being invisible.

Earlier, the connection port 8 was guided all down into the device's deep hole, and being there, established a seal encircling the prism or cylinder surface by means in the device 9. Thus liquid from the container 4 will be able to stream through the adapter 1 and further into the device 9 for utilization there, without liquids leakage or spill from the couplings: container [symbol] adapter and adapter [symbol] device.

The attachment means 2 with contact against the outlet area 5 can preferably consist of elastic material (FIG. 4: 12), e.g. rubber or plastic with corresponding elastic and sealing characteristics, that—just like all other liquid swept items in the container 4, the adapter 1 and the device 9—advantageously can be approved for use with food, so that migrated substances from these items will not in any crucial way effect any health related influence on the drink ability of the liquid taken out from the container 4.

Thus, with the attachment means 2 consisting of elastic material 12, form irregularities and dimension tolerances in the outlet area of the container 4 are easier taken up, to secure a safer sealing; at the same time there will be no requirement for a sealing elasticity of the container's material round the outlet area which thus can be stiff and hard.

Particularly, with the use of an elastomer 12 the sealing attack of the attachment means 2 in the outlet of the container 4 can effect in a mutual cohesive force, which is distinctively superior to the force effected by the sealing or positioning to the prism or cylinder 10, regardless of actual size of the container 4, and actual quantity and type of liquid present inside the container 4, resulting in, that said adapter 1—correctly mounted according to the directions—will stay connected to the container 4 in the case of the adapter's 1 removal from the device 9 by a force influenced on the container 4. Thus the risk, that a force contribution from even a high level of a column of heavy liquid can press the adapter 1 out of the outlet area of the container 4 at the moment of the force related most critical situation, where the adapter 1 being removed from the device 9, inter alia overcoming the sealing forces at the connection port 8, is avoided; the size of the container 4 will often promote the container body and not the adapter body 20 being influenced by the external force for the removal of the adapter 1 plus container 4 from the device 9. The attachment means 2 are able to provide a heavy sealing grip between the container 4 and the adapter 1. Thereby, it is avoided that the adapter 1 remains connected to the device 9 during the removal of the container 4 from the adapter 1, what would have caused waste of liquid as a consequence.

Such obvious pattern of handling is clearly deductive from FIG. 3, as the container 4 is the most obvious item to grip, in order to lift the container 4 and the adapter 1 from the device 9.

The attachment means 2 for contact in the outlet area can be shaped as an overall truncated cone 13 pointing in the liquid upstream direction. The same adapter 1 can by this means be used in different containers' outlet area 6 with differing internal diameters, according to a dimensional interval defined by the size of the truncated cone 13. So, different kinds of bottles can be used, regardless the type and the dimensions of a possible external screw thread, as the adapter's attack takes place inside the drain opening formed by the actual bottle neck, and regardless already known or predictable diameter variations of the outlet area. Such variations are presented by e.g. easy-to-get, recyclable bottles of standard or proprietary design from the consumer market, such plastic bottles having substantially comparable content of e.g. mineral drinking water. One producer's bottle design, despite same contained volume of liquid, is often deviating a little from other producers' bottle design as to a connection thread for a screw cap and to the dimensions of the drain opening 5.

The overall truncated cone 13 can in detail be of a shape tapered towards the end in constantly stepped form, substantially shaped as successively alternating adjacently placed circumferential ribs 14 and grooves 15 with respective characterizing diameter constantly decreasing to the tapered end (FIG. 1a). By this, a better defined force or sealing against the actual container's outlet area 6 is achieved, as a rib 14 with smaller diameter further inside the outlet area 6 can effect the sealing function against the outlet area 6 internal wall and other ribs 14 of larger diameter can provide a heavy force contributing to the cohesiveness of the container 4 and the adapter 1, even if the larger diameter material is stressed beyond its sealing limit and/or is only partly being in touch with the edge of the outlet area 6.

Containers, used several times, possibly during cycles in a recycling system, often have minor damages on the outlet's extreme area from blows or intruded objects, why it is an advantage establishing the sealing further inside the outlet area, where both the probability for occurrences of and the extent of damages are smaller. The force yielding grip between adapter 1 and container 4 can be established closer to the outlet area and is not so sensitive to locally lacking sealing; also greater variations or failures in cross section, e.g. egg shape compared to circular form, can be absorbed.

FIG. 4 shows seen in a frontal elevation, an example of a preferred embodiment of the invention's adapter 1 fitted into a container 4, with a sleeve of elastic material 12 connected to the bottle 4 in the drain opening 5. As the adapter 1 has been twisted or driven into the drain opening's outlet area 6 with force, the adapter 1 squeezes outwards from inside and seals the drain opening 5, so that liquid in the lying, more than half filled container 4 does not run out through the connection between adapter 1 and bottle 4. The automatic closing and locking and pressure equalizing valve 16 and the take-out valve 11, respectively, guarantees a sealing of the adapter's 1 other two openings towards the surroundings in the shown situation. Such position can also illustrate a partly filled bottle lying between consecutive situations of use of smaller amounts of the contained liquid in a device 9, according to the invention.

The above description of selected, illustrative, preferred embodiments of the adapter 1 and the use hereof according to the present invention must not be regarded as a limitation of the scope of the invention. Without deviating from the idea of the invention, the skilled person can of course carry out many different variations and modifications of the present invention, for example by other combinations of details of embodiments mentioned here, without going beyond the scope of the protection emanating from the following claims.

1. An adapter comprising attachment and connection means to establish both physical fit and flow connection between:
a container with one drain opening, otherwise closed—and being substantially rigid,
an at least occasionally liquid demanding device, where the attachment means have one attachment port for sealing connection to the drain opening of at least one such detachable and possibly replaceable container with properties to the surroundings, and
a valve being placed in fluid connection with the flow-passage between the attachment port and the connection means for the liquid demanding device for automatically pressure equalizing the inside container in relation to the surrounding pressure substantially simultaneously with the devices' draining of liquid from a such attached container, respectively,
characterized in,
the attachment means (2) at the attachment port (3) being configured to keep a presently utilized container (4) by means of a sealing attack in the drain opening (5) outlet area (6),
the connection means (7) being shaped as a connection port (8) having externally a substantially prismatic or cylindrical (10) form, which fits in a corresponding shaped deep hole in the device (9), wherein after a certain—substantially translatoric—mutual telescoping of the prism or cylinder (10) and the deep hole, a sealing to the prism or cylinder's surface between the interior of the deep hole and the surroundings is established by sealing means,
a spring biased take-out valve (11) being provided in the flow direction in the connection port (8) of the adapter (1), being opened by means in the device (9) after the sealing to the prism or cylinder (10) has been established; and that, conversely, the take-out valve (11) being closed during and at least briefly after invalidation of the sealing to the prism or cylinder (10) between the surroundings and the deep hole at mutual separation of the adapter (1) and the device (9).

2. An adapter according to claim 1, characterized in,
the sealing attack of the attachment means in the outlet (6) of the container (4) resulting in a mutual cohesive force, which is distinctively superior to the force produced by the sealing or positioning to the prism or cylinder (10), regardless of actual size of the container, and actual quantity and type of liquid present inside the container, resulting in, that said adapter (1) correctly mounted according to a directions, will stay connected to the container (4) in the case of the adapter's removal from the device (9) by force influenced on the container (4).

3. An adapter according claim 1 or 2, characterized in, the attachment means (2) having contact with the drain opening (5) wall consists of an elastomer (12).

4. An adapter according to any one or more of the previous claims, characterized in, that the attachment means (2) for contact in the outlet area (6) are shaped as an overall truncated cone (13) pointing in the liquid upstream direction.

5. An adapter according to claim 4, characterized in, the overall truncated cone (13) detailed having a towards the tapered end constantly stepped form substantially shaped as successively alternating adjacently placed circumferential ribs (14) and grooves (15) with constantly decreasing respective characterizing diameter to the tapered end.

6. An adapter according to any one or more of the previous claims, characterized in, the flow conduit of the pressure equalizing valve (16) joining to the flow passage immediately upstream of the take-out valve (11).

7. An adapter according to any one or more of the previous claims, characterized in, the valve part (17) of the pressure equalizing valve (16) being biased in the cut-off position by a flexible, preferably elastic, biasing force so small, that the pressure equalizing valve can open for pressure compensation with the fluid level being on level with the free surface of the attachment means in the outlet (6).

8. An adapter according to any one or more of the previous claims, characterized in, the means of the device (9) for opening of the take-out valve (11) is being controllable.

9. An adapter according to any one or more of the previous claims—at least claim 3, characterized in, the elastomer (12) of the attachment means being shaped as a sleeve (18), which is mounted on a supporting, preferably tubular, structure (19) of the adapter body (20).

10. An adapter according to any one or more of the previous claims, characterized in, the body (20) of the adapter (1) is shaped by moulding, preferably by injection moulding.

11. An adapter according to any one or more of the previous claims, characterized in, the adapter's (1) flow passage from the container (4) to the device (9) being substantially linear.

12. An adapter according to any one or more of the previous claims, characterized in, the attachment means (2) being designed for attack of the actually utilized container (4) exclusively in the outlet (6).

13. Use of an adapter according to any one or more of the previous claims, characterized in, the liquid being drinkable water, preferably mineral drinking water.

14. Use of an adapter according to anyone or more of the previous claims, characterized in, the container (4) being a bottle, preferably of transparent plastic material, preferably approved for use with human food.

15. Use of an adapter according to any one or more of the previous claims, characterized in, the device (9) being an espresso machine, preferably designed as a domestic appliance.
